(19) United States
(12) Patent Application Publication
(10) Pub. No.: US 2018/0207646 A1
(43) Pub. Date: Jul. 26, 2018

(54) METHOD AND APPARATUS FOR THE TWO-STAGE GRINDING OF FRESH STOCK

(71) Applicant: KHD Humboldt Wedag GmbH, Koeln (DE)

(72) Inventor: Siegfried STRASSER, Much (DE)

(21) Appl. No.: 15/744,916

(22) PCT Filed: Jul. 8, 2016
(86) PCT No.: PCT/EP2016/066309

§ 371 Date: Jan. 15, 2018

(30) Foreign Application Priority Data
Jul. 16, 2015 (DE) 102015009273.1

(51) Int. Cl. B02C 21/00; B02C 23/10; B02C 4/02; B02C 4/28; B02C 25/00

(52) U.S. Cl. CPC B02C 21/00; B02C 23/10; B02C 25/00; B02C 4/286; B02C 4/02

(57) ABSTRACT

A method and apparatus for grinding fresh stock, comprising comminuting the fresh stock in a first roller press roller gap into ground grinding stock, dividing the ground grinding stock via an adjustable divider into a first and second part stream in a variably adjustable ratio and comminuting the ground grinding stock of the first part stream in a second roller press. The adjustable divider divides ground grinding stock into an intermediate stream comprising ground grinding stock issuing from an intermediate roller gap region, and into two peripheral streams each comprising ground grinding stock issuing from one of the two roller gap peripheral regions. The two peripheral streams are combined to form the first part stream and the intermediate stream forms the second part stream. The second part stream is conveyed from the divider into a bypass line, passing the second roller press.

### CROSS-REFERENCES TO RELATED APPLICATIONS

This application claims the benefit of the German patent application No. 102015009273.1 filed on Jul. 16, 2015, the entire disclosures of which are incorporated herein by way of reference.

### BACKGROUND OF THE INVENTION

The invention relates to a method for grinding fresh stock, comprising the steps of comminuting the fresh stock to ground stock in the roller gap between two rotatably mounted rollers of a first roller press; dividing the ground stock at a variably adjustable ratio by means of adjustable separation means of a separator installation into a first part-flow of ground stock and into a second part-flow of ground stock; and comminuting the ground stock of the first part-flow to re-ground stock in a second roller press. The invention furthermore relates to a device, corresponding to the method, for grinding fresh stock, the device having a first roller press for comminuting the stock bed of the fresh stock to ground stock, wherein the first roller press has a roller gap between two rotatably mounted rollers; a separator installation for dividing the ground stock at a variably adjustable ratio by means of adjustable separation means into a first part-flow of ground stock and into a second part-flow of ground stock; and a second roller press that in the material flow direction is downstream of the separator installation, for comminuting the ground stock of the first part-flow to re-ground stock.

Roller presses (high-pressure roller presses, stock-bed roller mills) in which two counter-rotating rollers, configuring between them a roller gap, are used for comminuting granular, brittle stock such as, for example, cement clinker. The stock that is fed as fresh stock to the roller press is supplied to the roller gap in which the stock is comminuted under high pressure. The particles of the granular stock cause mutual stress while shear forces are largely avoided. The compressive stress leads to the stock being crushed to form flakes and to structural fractures that are created herein in the material enabling a deagglomeration and consequently the harvesting of small stock components in a subsequent method step, for example in static cascade classifiers. Therefore, roller presses are often part of a recirculating grinding plant in which the desired fine stock is extracted by means of the use of static pre-classifiers and dynamic post-classifiers, while rough stock that is separated out is kept in circulation and, together with freshly introduced fresh stock, is resupplied to the roller press for comminution.

In particular, in the case of recirculating grinding plants for the production of cement, a finished product which has a grain-size spectrum with a proportion of very fine granular particles that is as high as possible is targeted. This usually leads to a high cycle count of the stock, this being disadvantageous in terms of economy as well as process technology. A known approach for increasing the proportion of fine stock and, at the same time, keeping the number of transportation cycles as low as possible, is to dispose a second grinding device downstream of the roller press in a two-stage method. It is thus taught in the applicant's prior patent application, DE 10 2015 001 404 B3, to feed fresh stock for high-pressure comminution, in the case of a recirculating grinding plant for grinding fresh stock, to a first roller press and to dispose a second roller press downstream of the first roller press.

A particular challenge in terms of process technology lies in mutually adapting the operation of the two roller presses. Insofar as, on account of the fresh stock, for the most part rougher stock is supplied to the first roller press than to the second roller press into which already ground stock makes its way, the throughput in the case of the first roller press is, in principle, higher than in the case of the second roller press. On the basis of two roller presses of identical dimensions, any adaptation would have to be performed by reducing the number of revolutions, thus ultimately by reducing the output of the first roller press. Alternatively, an enlargement of the second roller press and/or the operating parameters of the latter would have to be performed, this being disadvantageous in terms of the expenditure in energy and costs.

In the recirculating grinding plant of the abovementioned patent application, DE 10 2015 001 404 B3, this problem in the adaptation of the operation of the roller presses that are disposed sequentially in two stages is alleviated in that the flow of the ground stock that exits from the roller gap of the first roller press is divided into two part-flows (at a variably adjustable mutual ratio). Since one of the two part-flows is guided directly to a pre-classifier, only the other part-flow reaches the stock feeding unit of the second roller press. Insofar as this part-flow has a lower mass flow than the material flow which is supplied to the first roller press, in terms of adapting the operation of the two roller presses there is not necessarily any requirement of a noticeable reduction in the revolutions or the throughput/output, respectively, of the first roller press or a disadvantageously increased requirement in terms of throughput or output, respectively, for the second roller. On the other hand, because of the bypass part-flow that bypasses the second roller press, the division of the flow of ground dock from the first roller press that is performed in this way leads to the proportion of fine stock in the total flow that is formed (actually or notionally) by both part-flows in the material flow direction behind the second roller press to being significantly limited. In a recirculating grinding plant, this, for a large proportion of stock, then leads to the disadvantage of a cycle count that is not reduced in an optimal manner. Furthermore, classifiers that are used in such a circuit have to be dimensioned larger the lower the proportion of fine stock that is supplied, this being disadvantageous at least in economic terms.

### SUMMARY OF THE INVENTION

It is therefore an object of the invention to specify a method for grinding fresh stock by way of a comminution that is carried out in two stages by disposing two roller presses in sequence, in which method the operation of the two roller presses can be mutually tuned in a suitable manner and in which the proportion of fine stock is overall increased. It is furthermore an object of the invention to provide a device for grinding fresh stock, the device corresponding to the method.

According to the invention, it is thus provided that the ground stock that exits from the roller gap of the first roller press is first divided by means of the separation means of the separator installation into a central flow of ground stock which is formed from ground stock that exits from a central (in relation to the longitudinal direction of the roller gap) roller gap region, and into two peripheral flows of ground stock which in each case are formed from ground stock that in each case exits from one of the two peripheral roller gap regions that are mutually spaced apart by the central roller gap region. It is thus not the case that the ground stock that exits continuously across the entire length of the roller gap is first to be combined to form a material flow which then in a next step is be divided into two part-flows of ground stock with the same characteristics. The guiding principle is rather the recognition of the fact that, in particular, as a result of the bulk cone which is created above the roller gap in the case of roller presses, in the case of fresh stock being fed typically in a central manner, the drawing-in behavior and the high-pressure comminution in the roller gap when viewed across the entire length of the roller gap do not proceed in a homogenous manner. In the central (in relation to the longitudinal extent of the roller gap) region of the roller gap, a comparatively large quantity of fed stock is drawn in and a high pressure prevails in the roller gap. Therefore, the highest degree of comminution is achieved in this central region in the case of fresh stock being fed centrally. The pressure and conjointly therewith the degree of comminution is reduced in each case toward the peripheries, i.e., along the roller gap toward the two end sides of the roller press. The exact function of the distribution of pressure along the roller gap in terms of the location depends, above all, on the operating parameters (roller contact pressure, revolutions, etc.) of the roller press and on the characteristics and the quantity of the fresh stock fed (and optionally of the recirculated material). Typically, the pressure in a specific region that is configured symmetrically to the center (as defined in relation to the longitudinal extent) of the roller gap is approximately constant or decreases only in a comparatively slight manner toward the outside, while the two peripheral regions are characterized by a greater drop in pressure in each case toward the outside (that is to say, in a manner that is approximately mutually mirror-symmetrical). Therefore, ground stock that is comminuted to a finer degree than at the peripheries is created in the center of the roller gap.

Therefore, the separator installation is disposed according to the invention directly below the roller gap so as to extend across the entire longitudinal direction of the latter, i.e., in spatial terms before a convergence of the proportions of ground stock that exit downward along the roller gap, so as to form one flow, could arise. The separator installation includes separation means, in one particular embodiment of the invention, for example, two adjustable flaps by way of which the ground stock that exits in a manner distributed across the roller gap can be divided into part-flows. According to the invention, the separation means are mutually disposed so as to be approximately symmetrical to the center of the roller gap that is defined in relation to the longitudinal extent of the roller gap. As a consequence of the function of the separation means, a central flow of ground stock, and in each case, one peripheral flow at either side of the central region, from the two peripheral regions of the roller gap, are created. The ground stock of the central region has a higher degree of comminution, that is to say, the ground stock of the central region in terms of the grain-size distribution spectrum is composed of more finely granulated material (that normally nevertheless still has to be deagglomerated) than the rougher ground stock of the peripheral flows.

The two peripheral flows are then combined. According to the invention, the part-flow of ground stock, which here for the sake of differentiation is referred to as the “first” part-flow, is formed by the two combined peripheral flows. The central flow of ground stock forms the second part-flow of ground stock. The percentagewise division of the total ground stock of the first roller press, at a mutual ratio of the two part-flows, thus depends directly on the division that has been carried out, that is to say, on the respective setting of the separation means. The first part-flow having the ground stock, present in a comparatively rough form, of the first roller press (from the peripheral regions) is now supplied to the second roller press for a further comminution procedure and is fed into the roller gap of the second roller press. This rougher proportion in the second roller press is thus re-ground to a re-ground stock, wherein the term “re-ground” refers to the additional comminution that is performed in this second stage here, and does not indicate any defective operating mode of the grinding device (in the sense of “excessive”).

Furthermore, according to the invention, the second part-flow having the comparatively finely ground stock (from the central region), by means of the separator device, is guided into a bypass line. The bypass line is connected to the separator installation, on the one hand, and directs the second part-flow of ground stock so as to bypass the second roller press, on the other hand. Typically, the second part-flow from the bypass line in grinding circuits will subsequently be combined with the re-ground stock of the second roller press so as to form a total flow, but the second part-flow and the re-ground stock in the case of an appropriate circuit topology could also continue to be kept separate. According to the invention, the ground stock of the first roller press is thus not only divided in purely quantitative terms, but into a finer and a rougher proportion. The part-flow having the finer proportion bypasses the second roller press; the part-flow having the rougher proportion is additionally re-ground. This not only has the advantage that the second roller press is de-stressed by being supplied with a material flow which is smaller than the material flow that is supplied to the first roller press, an advantageous mutual adaptation of the operation of the two roller presses in terms of the mutual throughput therefore being able to be achieved, but moreover, the grain-size distribution spectrum of the second part-flow (bypass) is shifted toward smaller grain sizes such that in the operation of the two-stage grinding device within a recirculating grinding plant, advantageously fewer cycles are required for achieving a finished product of very fine grain compared to what has been achieved to date in the prior art (by dividing into part-flows having approximately identical degrees of comminution). Classifiers which are typically present in the circuit, for instance in the production of cement, can be dimensioned so as to be smaller by virtue of the supplied more finely granulated material to be classified.

In a preferred design embodiment of the invention both roller presses have in each case one stock feeding device for feeding the respective stock to be ground into the corresponding roller gap. In the case of the two-stage comminution procedure, the typical operating parameters such as revolutions, contact pressure, as well as the dimensioning of the two roller presses for the normal operation are advantageously tunable to one another. However, in particular on account of a varying characteristic of the fresh stock and of the ground stock, as well as on account of deviations in the feeding of the stock into the first roller press, variations that are usually unforeseen arise in operation in the bulk feeding in the stock feeding devices and in the throughput in the roller presses. A modified percentagewise division that has been brought about between the two part-flows also leads to changed operating conditions. Therefore, a particularly advantageous design embodiment of the invention provides, for a controlled operation of the two-stage comminution device, that the filling level of the ground stock of the first part-flow, which stock is fed into the stock feeding device of the second roller press, is regulated as the process variable in a regulator circuit. In this regulator circuit, the actuated position of the separation means of the separator installation, thus for instance the angular and/or spacing setting of adjustable flaps, operates as the actuating variable since the position of the separation means sets the mass flow of the first part-flow (as well as of the second part-flow), that is to say, the mass that is moved through a cross section per unit of time (mass throughput), and thus also the filling level in the stock feeding device of the second roller press. A device for measuring the filling level of the ground stock of the first part-flow, which stock is fed into the stock feeding device of the second roller press, is provided for determining the actual value of the process variable. Measuring devices which are known per se, for example, pressure transducers or filling level sensors, can be used to this end.

In a further design embodiment of the invention it is furthermore provided that the stock feeding device of the second roller press, in particular for reasons of safety, has an overflow for discharging excess fed stock. It is avoided on account thereof that unforeseen variations in the feeding of stock, that arise rapidly, lead to overfilling of the stock feeding device of the second roller press. Material that is discharged by way of the overflow, that is to say, ground stock from the first part-flow, in order for the material to be kept in the circuit, is guided by way of a connection line into the bypass line that guides the second part-flow of ground stock.

In a further advantageous design embodiment of the invention it is provided that the first roller press has a stock feeding device for feeding the fresh stock, and that the filling level of the fresh stock (including any recirculated material) that is fed into the stock feeding device of the first roller press is regulated as the process variable in a regulator circuit in which the mass flow of the fresh stock to be fed is the actuating variable. Metering of the fresh stock fed can be achieved in this way by modifying the speed of supplying transportation belts or of throttling and metering devices known per se, for instance also while using metering belt balances, so as to adjust an approximately constant filling level that is suitable for the two-stage grinding method in the case of the first roller press. A disturbance variable herein can, in particular, be a variable quantity of recirculated material which is fed conjointly with the fresh stock to the first roller press for a further cycle. Furthermore, a person skilled in the art in a further design embodiment can establish a coupling to the regulator circuit described above for the filling level in the stock feeding device of the second roller press in that, for example, the filling level in the case of the first roller press is included in this regulator circuit as a further actuating variable.

Proceeding from the preferred embodiment of the method according to the invention, or of the device according to the invention respectively, in which the filling level of the ground stock of the first part-flow, which stock is fed into the stock feeding device of the second roller press, is regulated as the process variable in a regulator circuit by way of the position of the separation means as the actuating variable, provision is made in a further design embodiment of the invention for the actuation range of the actuating variable to be restricted in a suitable manner. Insofar as the percentagewise division of the mass flows of the first and of the second part-flow correlates with the position of the actuating means, for example of adjustable flaps, this parameter can be formulated as the mutual ratio of mass flows. Extensive test runs in recirculating grinding plants for the production of cement have surprisingly demonstrated that for an optimal tuning of the operation of the two roller presses to one another and for an efficient reduction of the cycle counts in the circuit, the following is to be chosen as such a condition for regulating the filling level in the stock feeding device of the second roller press: the mass flow of the second part-flow of ground stock is to be at least 10% and at most 40%, preferably at least 15% and at most 30%, of the total mass flow, the latter being defined as the sum of the mass flows of the first part-flow and of the second part-flow of ground stock.

In the case of the embodiment of the invention with an overflow at the stock feeding device of the second roller press and infeeding of excess fed stock into the bypass line, measurements in the case of a typical operation of the device according to the invention within a recirculating grinding plant for producing cement have demonstrated that, as an alternative embodiment of the invention, the following is advantageous for the parameter set the actuator range of the actuating variable in the regulator circuit: the mass flow of the material flow that is created by introducing the excess fed stock of the second roller press into the bypass line that guides the second part-flow of ground stock is to be at least 10% and that most 40%, preferably at least 15% and at most 35%, of the total mass flow, the latter being defined as the sum of the mass flows of the first part-flow and of the second part-flow of ground stock.

In order for the two alternative regulator circuits that are in each case provided with the aforementioned parameters to be implemented, a first device for measuring the mass flow is provided in the bypass line between the separator installation and, if present, the introduction point of the excess fed stock, in a design embodiment of the device according to the invention. Additionally or alternatively thereto, a second device for measuring the mass flow of the material flow that is composed of the ground stock of the second part-flow and of the excess fed stock is provided, i.e., directly behind the introduction point of the excess fed stock into the bypass line. Measuring apparatuses known per se for determining mass flows in lines, for instance based on radiometrics, can be used as measuring devices. In order for the percentagewise ratios to be obtained, the values detected have to relate to the mass flow of the total flow. The latter can be determined during the supply of the feed flow of the first roller press, which flow is composed of fresh stock and recirculated stock. A determination of the mass flow of the re-ground stock which exits from the second roller press is also particularly suitable (especially in the case of an overflow at the first roller press), in the simplest case once the mass flow of the re-ground stock has been unified with the mass flow that exits from the bypass line. Since a transportation of material typically takes place here on transportation belts, a belt balance, for example is suitable for this third mass-flow measuring device.

The method according to the invention proposed and the corresponding device according to the invention are not limited to the embodiments that are explicitly introduced here. Firstly, in particular, a method management in three stages or even more stages can be achieved in principle when further roller presses according to the principle introduced, that is to say, like the second roller press, are disposed downstream. Secondly, another division into part-flows can moreover also be performed if required, that is to say, into one central flow and two combined peripheral flows of approximately equal size, by way of corresponding separation installations and separation means, respectively, along the roller gap of the first roller press. A person skilled in the art will be able to readily implement this when an impingement of the roller gap with stock is performed that is asymmetrical or otherwise departs from the normal case. The specific separation can then be adapted by way of a corresponding installation of actuating means to the given function of pressure distribution or of the degree of comminution, respectively, along the roller gap such that rougher stock is separated from finer stock and comminuted a second time.

### BRIEF DESCRIPTION OF THE DRAWINGS

The invention will be explained in more detail by means of the following figures in which

FIG. 1 shows a schematic illustration of the two-stage method according to the invention for grinding fresh stock; and

FIG. 2 shows a schematic illustration in a lateral perspective of the division into part-flows downstream the first roller press.

### DETAILED DESCRIPTION OF THE PREFERRED EMBODIMENTS

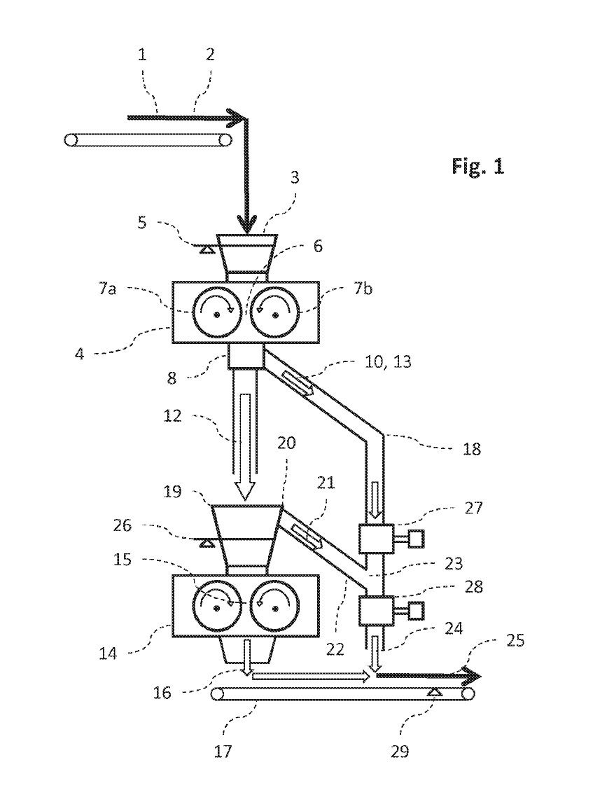

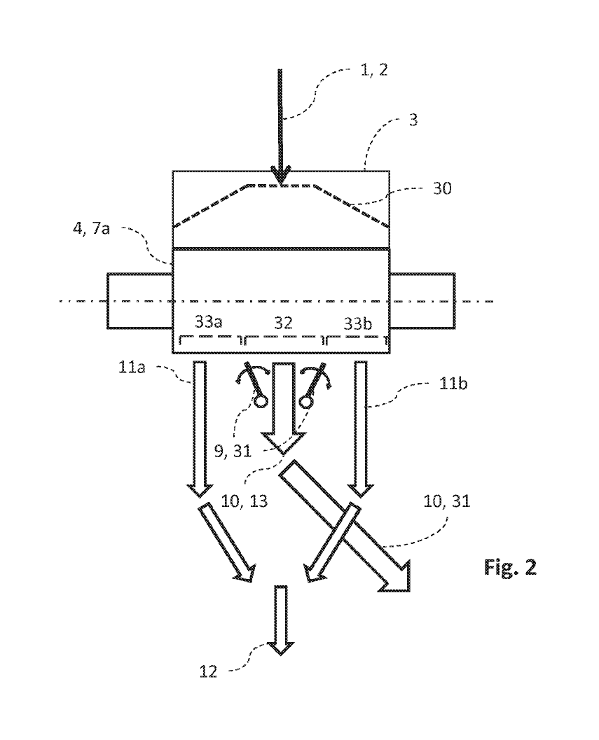

An exemplary embodiment of the method according to the invention for grinding granular, brittle fresh stock 1 by way of a corresponding device according to the invention is schematically illustrated in FIG. 1. Fresh stock 1, optionally conjointly with the stock 2 that has been recirculated in a recirculating grinding plant (not completely illustrated), is fed into the stock feeding device 3 of the first roller press 4. In order for the fed quantity to be metered in a suitable manner, the filling level 5 in the stock feeding device 3 is controlled and is regulated in a regulator circuit having the mass flow of the fresh stock 1 to be fed as an actuating variable. The fresh stock 1 (conjointly with recirculated stock 2) is comminuted to ground stock under high pressure in the roller gap 6 between the rollers 7a, 7b of the first roller press 4 and herein is crushed to form flakes. A separator installation 8 is disposed directly below the entire roller gap 6 in the longitudinal extension thereof. The ground stock that in the normal case continuously exits downward from the roller gap 6 over the entire length thereof is combined by means of adjustable separation means 9 (FIG. 2) that are disposed in the separator installation 8, the ground stock herein being divided into a central flow 10 of ground stock and into two peripheral flows 11a, 11b of ground stock. The normal case of stock being fed by means of the stock feeding device 3 in a central manner (when viewed in the longitudinal extent) above the roller gap 6 is assumed here. By virtue of the distribution of pressure along the roller gap 6, the central flow 10 is composed of more intensely comminuted material, i.e., material that on average is more finely granulated, than the two peripheral flows 11a, 11b. The two peripheral flows 11a, 11b are combined to form a first part-flow 12 of ground stock; the central flow 10 forms a second part-flow 13. The mutual mass-flow ratio of the two part-flows 12, 13 is determined by the separator installation 8 (by way of the position of the separation means 9).

According to the invention, the rougher ground stock of the first part-flow 12 is supplied to a second roller press 14 and in the roller gap 15 of the latter is comminuted to re-ground stock 16. The first roller press 4 is advantageously disposed vertically above the second roller press 14 or else above the latter but so as to be laterally offset such that the transportation of the ground stock of the first part-flow 12 is performed in an economically favorable manner by gravity. In principle however, transportation by means of a transportation device is also possible. The re-ground stock 16 in the exemplary embodiment illustrated is conveyed onward by means of a transportation belt 17, that is to say, in particular, transported to the classifiers of a recirculating grinding plant (and herein is optionally first fed into a pneumatic conveyor). Furthermore, according to the invention, the more finely granulated ground stock of the second part-flow 13 is not guided to the second roller press 14, but past the latter in a bypass line 18. The second roller press 14 on account thereof can operate at a lower throughput than the first roller press 4 such that a suitable tuning of the operating parameter (in particular of the revolutions) of the two roller presses 4, 14 is achievable without having to reduce the output of the first roller press 4. The division into the part-flows 12 and 13 with the different grain-size distributions thereof has the advantage that the bypass is formed by the more finely granulated ground stock proportion. This within a recirculating grinding plant reduces the number of recirculation cycles of non-classified material and overall increases the fine granularity in the finished product.

The second roller press 14 likewise has a stock feeding device 19. For reasons of safety in terms of unforeseeable, rapid variations in the mass flow of the first part-flow 12 that are, as such, difficult to avoid, an overflow 20, by way of which excess fed stock 21 is guided through a connection line 22 into the bypass line 18 at the introduction point 23, is provided. The material flow 24 that is composed of the excess fed stock 21 that is optionally present and of the second part-flow of ground stock is released in the exemplary embodiment illustrated onto the transportation belt 17 where the material flow 24 conjointly with the re-ground stock 16 forms the total mass flow 25, i.e., the sum of the mass flows of the first part-flow 12 and of the second part-flow 13.

The operation of the two sequentially disposed roller presses 4, 14 can be mutually tuned in an optimal manner when the filling level in the stock feeding device 19 into which the first part-flow 12 is fed is regulated as the process variable in a regulator circuit. The actuated position of the separation means 9 in the separator installation 8 is used as the actuating variable in the regulator circuit, that is to say, that a controlled modification of the proportional division of the first part-flow 12 and the second part-flow 13, or of the percentagewise proportion of the total mass flow 25 made up by the bypass-type second part-flow 13 is brought about.

Apart from a continually performed measurement of the filling level 26 in the stock feeding device 19 of the second roller press 14, the following is provided for carrying out the regulation: a first device 27 for measuring the mass flow of the second part-flow 13 of ground stock in the bypass line 18 between the separator installation 8 and the introduction point 23; and (/or) a second device 28 for measuring the mass flow of the material flow 24 that is composed of the second part-flow 13 and of the excess fed stock after the introduction point 23; and a third device 29 for measuring the mass flow of the total mass flow 25, the latter in the exemplary embodiment illustrated being provided as a belt balance 29. The regulator circuit for the filling level 26 in the stock feeding device 19 of the second roller press 14 can be operated under parameters set for the actuation range of the actuating variable (the position of the separation means 9) with the aid of the measuring values that are acquired continuously or at regular discrete temporal intervals. For example, for the operation within a typical recirculating grinding plant for producing cement, a proportion of the total mass flow 25 made up by the mass flow of the second part-flow 13 that is diverted as a bypass of at least 10% and at most 40%, preferably at least 15% and at most 30% proves to be advantageous for a sufficiently fine grain-size distribution in the finished product, for a suitable mutual tuning of the roller presses 4, 14, and for an economically favorable low number of cycles in the circuit.

The supply of the fresh stock 1, optionally conjointly with stock 2 that is recirculated in a grinding circuit, to the stock feeding device 3 of the first roller press 4 is illustrated in a schematic lateral illustration at the top of FIG. 2. Because of the lateral perspective, only one roller 7a of the first roller press 4 can be seen. The stock 1, 2 that is fed in a central manner typically forms a flattened bulk cone 30 above the roller gap 6 (obscured in the illustration) having the greatest height in the center and decreasing in height towards the peripheries, in each case, in relation to the longitudinal extent of the rollers 7a, 7b, or of the roller gap 6, respectively. The separator installation 8 (not illustrated in its entirety) having the separation means 9 is disposed directly below the roller gap. The division in the exemplary embodiment illustrated is performed mechanically by adjustable flaps 31. The flaps 31 that are located in the housing of the separator installation 8 that extends below the entire roller gap 6 are disposed so as to be mirror-symmetrical to the center of the longitudinal extent of the roller gap and so as to be movable, for example by way of a motor. The flaps 9, 31 can be displaceable in opposite mutual directions below the roller gap 6 or, as in the exemplary embodiment illustrated, pivotable in the angular position thereof (in mutually opposite directions) about a rotation axis.

On account of the respective defined position of the separation means 9, 31 in which, in a purely geometrical manner, a central roller gap region 32 (marked in a symbolic manner) is delimited along the roller gap 6 from, in each case, one peripheral roller gap region 33a, 33b that is located to the left and to the right (in the illustration) thereof by way of the (free) ends of the flaps 9, a division of the ground stock that exits in a downward manner from the entire roller gap 6 into a central flow 10 of finer ground stock and into, in each case, one peripheral flow 11a, 11b of rougher ground stock takes place. As has been described in the context of FIG. 1, the central flow 10 as a second part-flow 13 is furthermore directed as a bypass around the second roller press 14 while the peripheral flows 11a, 11b conjointly form the first part-flow 12 which for re-grinding is fed into the second roller press 14.

In the case of a potential other distribution of pressure, or of the degree of comminution, respectively, along a roller gap 6, a corresponding advantageous division into part-flows having mutually dissimilar particle-size distributions of particle sizes can be performed by a person skilled in the art by way of a correspondingly adapted separator installation 8.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE SIGNS

1 Fresh stock
2 Recirculated stock
3 Stock feeding device (first roller press)
4 Roller press (first)
5 Filling level (first roller press)
6 Roller gap (first roller press)
7a, 7b Roller (first roller press)
8 Separator installation
9 Separation means
10 Central flow
11a, 11b Peripheral flow
12 First part-flow
13 Second part-flow
14 Roller press (second)
15 Roller gap (second roller press)
16 Re-ground stock
17 Transportation belt
18 Bypass line
19 Stock feeding device (second roller press)
20 Overflow
21 Excess fed stock
22 Connection line
23 Introduction point
24 Material flow
25 Mass flow (total)
26 Filling level (second roller press)
27 Mass flow measuring device (first)
28 Mass flow measuring device (second)
29 Mass flow measuring device (third)
30 Bulk cone
31 Flap
32 Central roller gap region
33a, 33b Peripheral roller gap region

1-10. (canceled)

11. A method for grinding fresh stock comprising the steps of:
comminuting the fresh stock to ground stock in a roller gap between two rotatably mounted rollers of a first roller press;
dividing the ground stock at a variably adjustable ratio by means of an adjustable separator of a separator installation into a first part-flow of ground stock and into a second part-flow of ground stock; and
comminuting the ground stock of the first part-flow to re-ground stock in a second roller press;
further comprising:
dividing the ground stock that exits from the roller gap of the first roller press by means of the separator of the separator installation
into a central flow of ground stock which is formed from ground stock that exits from a central, in relation to a longitudinal direction of the roller gap, roller gap region; and
into two peripheral flows of ground stock which, in each case, are formed from ground stock that, in each case, exits from one of two peripheral roller gap regions that are mutually spaced apart by the central roller gap region;
wherein a combination of the two peripheral flows of ground stock forms the first part-flow of ground stock, and the central flow of ground stock forms the second part-flow of ground stock; and
guiding the second part-flow of ground stock from the separator installation in at least one bypass line so as to bypass the second roller press.

12. The method as claimed in claim 11,
wherein the second roller press has a stock feeding device for feeding the ground stock of the first part-flow, and
wherein a filling level of the ground stock of the first part-flow, which stock is fed into the stock feeding device of the second roller press, is regulated as a process variable in a regulator circuit in which an actuated position of the separator of the separator installation is an actuating variable.

13. The method as claimed in claim 12, wherein the stock feeding device of the second roller press has an overflow for discharging excess fed stock, wherein the excess fed stock is directed into the at least one bypass line that guides the second part-flow of ground stock.

14. The method as claimed in claim 12, further comprising regulating the filling level of the ground stock of the first part-flow, which stock is fed into the stock feeding device of the second roller press, under parameters set for an actuation range of the actuating variable formed by the actuated position of the separator, wherein a mass flow of the second part-flow of ground stock is at least 10% and at most 40%, of a total mass flow, the total mass flow being defined as a sum of mass flows of the first part-flow and the second part-flow of ground stock.

15. The method as claimed in claim 13, further comprising regulating the filling level of the ground stock of the first part-flow, which stock is fed into the stock feeding device of the second roller press, under parameters set for an actuation range of the actuating variable formed by the actuated position of the separator, wherein a mass flow of the material flow that is created by introducing the excess fed stock of the second roller press into the bypass line that guides the second part-flow of ground stock is at least 10% and at most 40% of a total mass flow, the total mass flow being defined as a sum of the mass flows of the first part-flow and of the second part-flow of ground stock.

16. The method as claimed in claim 11,
wherein the first roller press has a stock feeding device for feeding the fresh stock; and
wherein a filling level of the fresh stock that is fed into the stock feeding device of the first roller press is regulated as a process variable in a regulator circuit in which a mass flow of the fresh stock to be fed is an actuating variable.

17. A device for grinding fresh stock, said device comprising:
a first roller press for comminuting a stock bed of the fresh stock to ground stock, wherein the first roller press has a longitudinally extending roller gap between two rotatably mounted rollers;
a separator installation configured to divide the ground stock at a variably adjustable ratio by means of adjustable separator elements into a first part-flow of ground stock and into a second part-flow of ground stock; and
a second roller press that, in the material flow direction, is downstream of the separator installation, configured to comminute the ground stock of the first part-flow to re-ground stock;
the separator installation being disposed directly below the roller gap of the first roller press, wherein
the separator elements are mutually disposed so as to be approximately symmetrical to a center of the roller gap that is defined in relation to a longitudinal extent of the roller gap, in order to divide the ground stock that exits from the roller gap into
a central flow of ground stock formed from ground stock that exits from a central, in relation to the longitudinal extent of the roller gap, roller gap region; and into
two peripheral flows of ground stock which, in each case, are formed from ground stock that, in each case, exits from one of the two peripheral roller gap regions that are mutually spaced apart by the central roller gap region; and wherein
the first part-flow of ground stock is defined as a combination of the two peripheral flows of ground stock and the second part-flow of ground stock is defined as the central flow of ground stock; and wherein
at least one bypass line is connected to the separator installation and is configured to guide the second part-flow of ground stock to bypass the second roller press.

18. The device as claimed in 17, further comprising
the second roller press having a stock feeding device for feeding the ground stock of the first part-flow;
a device for measuring a filling level of the ground stock of the first part-flow, which stock is fed into the stock feeding device of the second roller press;
wherein the filling level of the ground stock of the first part-flow, which stock is fed into the stock feeding device of the second roller press, is integrated as a process variable into a regulator circuit in which an actuated position of the separator elements of the separator installation is an actuating variable.

19. The device as claimed in claim 18, wherein
the stock feeding device of the second roller press has an overflow for discharging excess fed stock;
a connection line for introducing the excess fed stock into the at least one bypass line is provided between the overflow of the stock feeding device of the second roller press and the at least one bypass line; and
at least one of
a first device configured to measure the mass flow in the bypass line is provided between the separator installation and the introduction point of the excess fed stock, or
a second device configured to measure the mass flow of the material flow that is composed of the ground stock of the second part-flow and any excess fed stock; and
a third device configured to measure the mass flow of the flow of the re-ground stock from the second roller press.

20. The device as claimed in claim 17, wherein the separator installation has two adjustable separator elements, wherein the separator elements comprise adjustable flaps.

21. The method as claimed in claim 14, wherein the mass flow of the second part-flow of ground stock is at least 15% and at most 30%, of the total mass flow.

22. The method as claimed in claim 15, wherein the excess feed stock is at least 15% and at most 35%, of the total mass flow.
